(19) United States
(12) Patent Application Publication
(10) Pub. No.: US 2014/0094304 A1
(43) Pub. Date: Apr. 3, 2014

(54) Apparatus and Method for In-Game Video Capture

(71) Applicant: RED ROBOT LABS, INC., Mountain View, CA (US)

(72) Inventors: John Harris, San Mateo, CA (US); Michael Ouye, Los Altos, CA (US); Peter Hawley, Menlo Park, CA (US); Brandon Jue, Sunnyvale, CA (US)

(73) Assignee: RED ROBOT LABS, INC., Mountain View, CA (US)

(21) Appl. No.: 14/040,349

(22) Filed: Sep. 27, 2013

Related U.S. Application Data
(60) Provisional application No. 61/707,764, filed on Sep. 28, 2012.

(51) Int. Cl. A63F 13/00

(52) U.S. Cl. CPC A63F 13/00
USPC 463/31

(57) ABSTRACT

A non-transitory computer readable storage medium has instructions executed by a processor to activate a camera, display a combination of a game in play and a video of a game player while the game is in play, and deactivate the camera upon termination of the game. The combination of the game in play and the video of the game player while the game is in play may be recorded for subsequent access.

### CROSS-REFERENCE TO RELATED APPLICATION

This application claims priority to U.S. Provisional Patent Application 61/707,764, filed Sep. 28, 2012, the contents of which are incorporated herein by reference.

### FIELD OF THE INVENTION

This invention relates generally to electronic games. More particularly, this invention relates to augmenting an electronic game with an in-game video feed of the game player.

### BACKGROUND OF THE INVENTION

Various electronics platforms support the ability to play interactive games, which continue to grow in popularity. A game may be played against the game application or against other users executing the same game application.

It would be desirable to enrich and diversify the interactive game experience.

### SUMMARY OF THE INVENTION

A non-transitory computer readable storage medium has instructions executed by a processor to activate a camera, display a combination of a game in play and a video of a game player while the game is in play, and deactivate the camera upon termination of the game. The combination of the game in play and the video of the game player while the game is in play may be recorded for subsequent access.

### BRIEF DESCRIPTION OF THE FIGURES

The invention is more fully appreciated in connection with the following detailed description taken in conjunction with the accompanying drawings, in which:

FIG. 1 illustrates a system configured in accordance with an embodiment of the invention.

FIG. 2 illustrates processing operations associated with an embodiment of the invention.

FIG. 3 illustrates a user interface to invoke in-game video capture.

FIG. 4 illustrates a user interface displaying a game with in-game video capture.

FIG. 5 illustrates a system configured in accordance with another embodiment of the invention.

Like reference numerals refer to corresponding parts throughout the several views of the drawings.

### DETAILED DESCRIPTION OF THE INVENTION

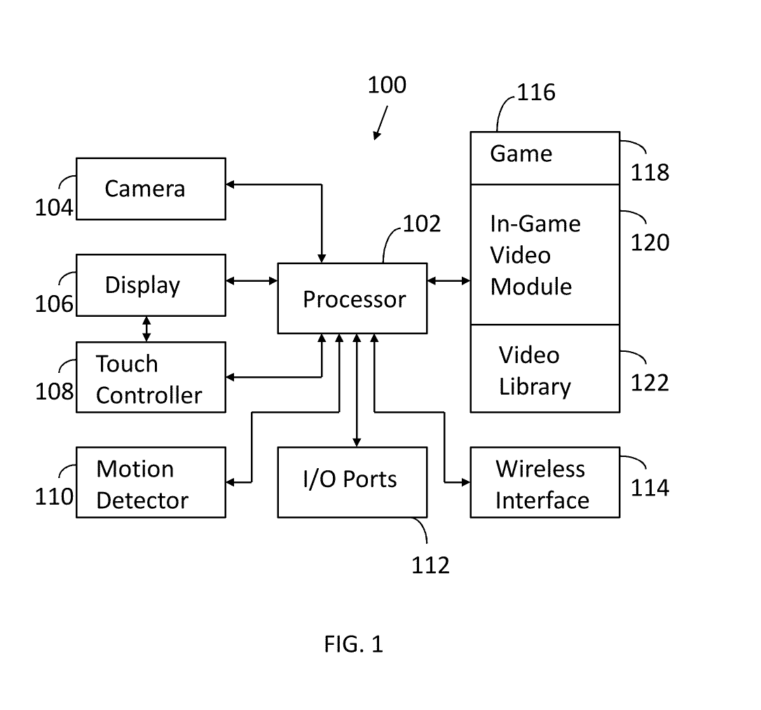

FIG. 1 illustrates a system 100 configured in accordance with an embodiment of the invention. In this embodiment, the system 100 is in the form of a mobile device, such as Smartphone. The system 100 includes a processor 102, which may a central processing unit and/or graphics processing unit. A camera 104 is connected to the processor 102. The camera 104 may be a user-facing camera on the mobile device and/or an outward-facing camera of the mobile device. A display 106 is also connected to the processor 102. The display 106 is a touch display with an associated touch controller 108. A motion detector 110 is also connected to the processor 102. The motion detector 110 may be a gyroscope, accelerometer and the like, which are responsive to movement during game play. Input/output ports 112 are also connected to the processor 102. The input/output ports 112 may include a microphone to collect commentary from a user while a game is in play. A wireless interface 114 provides a wireless connection to support cellular communications.

A memory 116 is also connected to the processor 102. The memory 116 stores at least one game 118. Game 118 may be any interactive electronic game. An in-game video module 120 is also stored in memory 116. The in-game video module 120 stores executable instructions to implement operations of the invention. In particular, the in-game video module 120 stores executable instructions to display a combination of a game in play and a video of the game player while the game is in play. The combination of the game in play and the video of the game player while the game is in play may be recorded and then stored in a video library 122 for subsequent access.

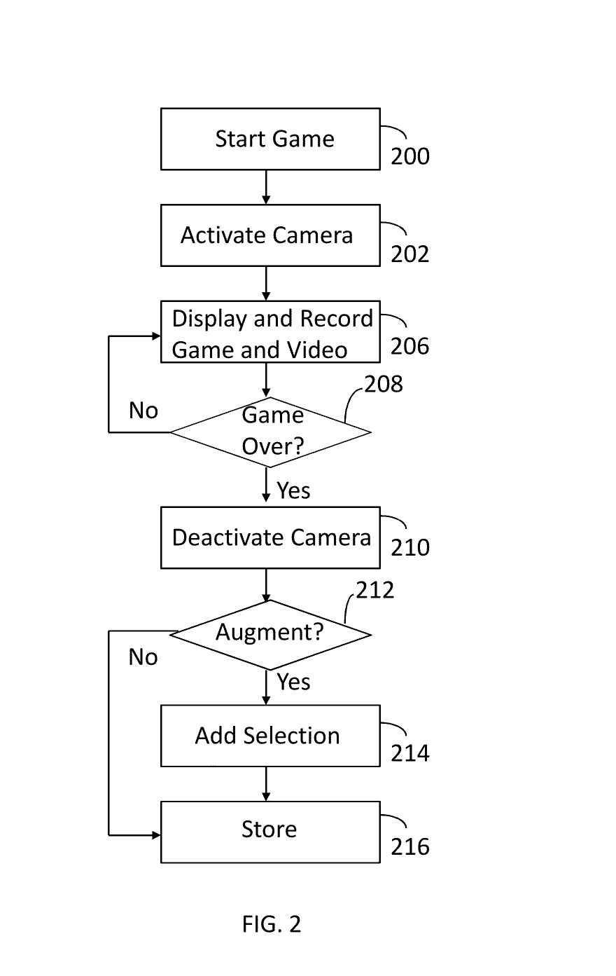

FIG. 2 illustrates processing operations associated with an embodiment of the invention. A game is initiated 200. For example, game 118 may be loaded into processor 102 for play. This action may activate a camera 202. For example, the in-game video module 120 may identify the initiation of the game and send a command to the processor 102 to activate the camera 104.

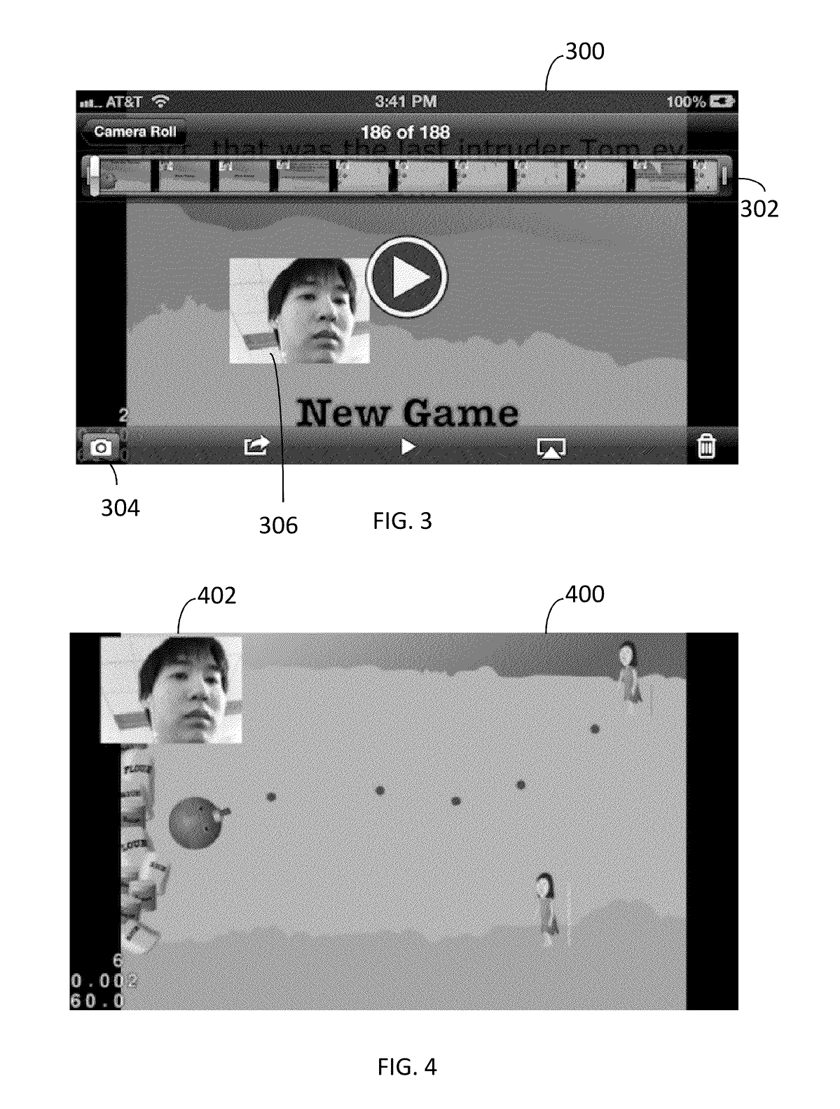

Thereafter, the game and the video are displayed and recorded 206. For example, the game may be displayed on display 106. FIG. 3 illustrates a user interface 300 of a mobile device at the initiation of game play. The user interface 300 includes various controls 304, one of which may be used to deactivate the camera or re-activate the camera. FIG. 3 illustrates that the user interface may also include a camera role 302 of previous frames of the game. FIG. 3 also illustrates a picture-in-picture 306 of a game player.

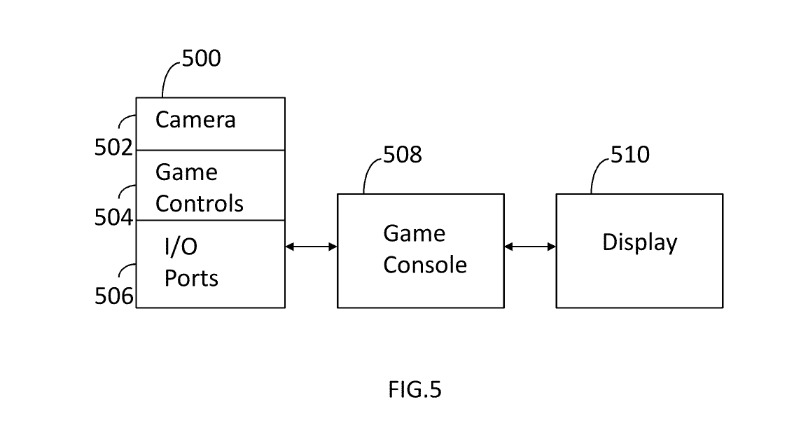

FIG. 4 illustrates a user interface 400 of the mobile device while the game is in play. The user interface includes a video feed 402 of the game player while the game is in play.

Returning to FIG. 2, the next processing operation is to determine whether the game is over 208. If the game is not over (208—No), control returns to block 206. If the game is over (either by completion of the game or termination of the game by the user), the camera is deactivated 210. At this point, the user is optionally prompted to augment the video 212. If the user does not augment the video (212—No), then the video is stored 216. The video may be stored in video library 122. If the users wishes to augment the video (212—Yes), a selection is added to the video 214 and then the video is stored 216. For example, the selection may be in the form of a sound track added to the video, as discussed below. Alternately, the selection may be in the form of a special effect added to the video.

FIG. 5 illustrates an alternate embodiment of the invention. In this embodiment, a game controller 500 includes a camera, game controls (e.g., buttons and a joystick) and input/output ports 506 to communicate with a game console 508. The game console 508 is connected to a separate display 510 (e.g., a television or monitor). The game console 508 incorporates the processor 102 and memory 116, with game 118, in-game video module 120 and video library 122.

Now that the invention has been fully disclosed, attention turns to different implementation details that may be used in accordance with embodiments of the invention.

The in-game video module 120 may be executed in response to a gesture applied to the display 106, as indicated by control signals from the touch controller 108. For example, a swipe applied to the display 106 may initiate video capture. This gesture activates the in-game video module 120 and its associated recording mechanism. As a result, a video of the game player appears on-screen as an overlay on top of the game. As shown in FIG. 3, a user interface 300 may provide a record button and an option for a user to turn on/off the picture-in-picture recording system.

Once the record button is pressed, the software begins to capture the game play footage from the screen. In one embodiment, this includes footage of game play from 30 seconds prior to the record button being pressed. The prior footage is shown as camera roll 302 in FIG. 3.

If the picture-in-picture mode has been selected, the system also activates the device's user-facing camera and microphone to record the user along with the game play footage. Alternately, the outward-facing camera may be used.

A window (e.g., 306, 402) appears as a small overlay on top of the game play. This picture-in-picture window can be moved around the screen by the user to ensure it is in the optimal position for subsequent viewing. For example, a gesture may be applied to the window to alter its position.

Users record game play for the desired period of time, along with their own commentary. When the desired period has been captured, users deactivate the recording by again pushing the record button. Alternately, the camera may be deactivated upon termination of the game.

Upon termination of a game, a user interface may be presented to allow users to manage the video content and export it to share with other users. At this point the user is also given an option to include audio from ar music library as part of the resulting content package.

In one embodiment, the in-game video module 120 grabs video and/or audio data, assigns it a time relative to the start of the recording and saves the recording. In one embodiment, the OpenGL® Application Program Interface (API) is used collect frame buffers from the GPU to write to the video. For example, beginning and ending rendering calls may be used to capture frame buffers. In one embodiment, a beginning call keeps track of the frame number and redirects every other frame to the video recorder instead of the display (i.e, if even send to display, if odd save to video). An ending call is used if the frame buffer has been redirected to the video and writes to the video after any necessary processing, such as appending the picture-in-picture. The picture to append is obtained from an instance variable containing the last camera image captured. A variable may be used to capture the difference between the recording start time and the current time.

The in-game video module 120 may include a user interface kit. In one embodiment, the user interface kit renders the window layer into a CGContext with renderInContext: of the iOS® developer library. The CGContext may be saved as an image. The CMTime variable of the iOS® developer library may be set to the difference between the recording start time and the current time.

The AVCaptureSession of the iOS® developer library may be used to retrieve CMSampleBuffers in the callback delegate captureOutput:didOutputSampleBuffer:fromConnection:. The CMTime returned by the CMSampleBuffer may be used. CMSampleBuffer may be saved to the AVAssetWriterinput setup with AVMediaTypeVideo. If the camera is used for picture-in-picture, instead of saving to the recording, one may save the CMSampleBuffer to an image to be used by the next video frame.

The foregoing discussion applies to the user of the user-facing camera or the outward-facing camera. Both cameras may also be used in accordance with an embodiment of the invention. In this mode, a user can switch back and forth between cameras while recording. This may be implemented in iOS® by setting up TWO AVCaptureSessions (one for each camera). Each AVCaptureSession saves out its own ‘last camera frame.’ The user input changes which AVCaptureSessions ‘last camera frame’ will be used during processing.

The video may be augmented with an audio track. For example, in iOS® the microphone input may be used in connection with an AVCaptureSession to retrieve CMSampleBuffers in the callback delegate captureOutput:didOutputSampleBuffer:fromConnection:. This approach uses the CMTime returned by the CMSampleBuffer. CMSampleBuffer saves to the AVAssetWriterinput setup with AVMediaTypeAudio.

Game audio may be captured by hooking into where the developer sends the sound to the application to be played (Cocos Denshion for Cocos2d). A copy of any instructions sent for that sound (start and stop times) may also be saved. These sounds may be replayed at the end with their start and end time data the same way an iTunes® song is added (one track per sound played). Each sound may be decompressed to grab the sound buffers and append them to the video as it plays. Start and end times and their relative position to the recording start time may be used to determine sound placement.

In one embodiment, other iOS® hooks may be used. For example, AVFoundation may be used to write the buffers into a video with AVAssetWriter. Data may be recorded with AVCaptureSession. The following iOS® core methods may also be used:
CoreMedia—CMSampleBuffers fetched through AVCaptureSessions, CMTime library
CoreAudio—AudioBufferList returned in audio CMSampleBuffers
CoreVideo—CVImageBufferRef returned in video CMSampleBuffers, used to edit data (pasting picture-in-picture onto frame)
Corelmage—Converts CVImageBufferRef to CIImage to CGImage to resize and save for future appending
CoreGraphics—Graphics manipulation (CGAffineTransform, renderinContext:, CGContextDrawImage, etc)
MediaPlayer—Select from iTunes® library
AssetsLibrary—Items selected from the device libraries (e.g., iTunes®)
MobileCoreServices—Provides constants

A video may be augmented with an audio track. For example, using iOS®, once the video is recorded, the user is presented with an MPMediaPickerController of the iOS® developer library. The user may select a song from their iTunes® account. AVMutableComposition is used to combine AVMutableCompositionTrack of the recorded video with the two AVMutableCompositionTrack of the recorded audio and the iTunes® song. The composition may then be exported as a new asset via AVAssetExportSession.

Post processing may include saving the video as a temporary file while it is being written. Once writing has completed, one may optionally add background music/sounds (iTunes® or game audio). The composition may then be saved to the video library 122.

An embodiment of the present invention relates to a computer storage product with a non-transitory computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media, optical media, magneto-optical media and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A non-transitory computer readable storage medium with instructions executed by a processor to:
activate a camera;
display a combination of a game in play and a video of a game player while the game is in play; and
deactivate the camera.

2. The non-transitory computer readable storage medium of claim 1 further comprising instructions executed by a processor to record the combination of the game in play and the video of the game player while the game is in play.

3. The non-transitory computer readable storage medium of claim 1 further comprising instructions executed by a processor to augment the combination of the game in play and the video of the game player while the game is in play.

4. The non-transitory computer readable storage medium of claim 1 further comprising instructions executed by a processor to augment with an audio track the combination of the game in play and the video of the game player while the game is in play.

5. The non-transitory computer readable storage medium of claim 1 further comprising instructions executed by a processor to reposition the video of the game player.

6. The non-transitory computer readable storage medium of claim 1 further comprising instructions executed by a processor to activate the camera upon initiation of the game.

7. The non-transitory computer readable storage medium of claim 1 further comprising instructions executed by a processor to deactivate the camera upon completion of the game.

8. The non-transitory computer readable storage medium of claim 1 further comprising instructions executed by a processor to play and record an audio track of the game player while the game is in play.

9. The non-transitory computer readable storage medium of claim 1 wherein the instructions are executed by a processor of a mobile device including the camera and a display.

10. The non-transitory computer readable storage medium of claim 1 wherein the instructions are executed by a processor of a game console connected to a game controller with the camera.

11. The non-transitory computer readable storage medium of claim 10 wherein the game console is connected to a display.
